(19) United States
(12) Patent Application Publication
(10) Pub. No.: US 2024/0256992 A1
(43) Pub. Date: Aug. 1, 2024

(54) CLIK

(71) Applicant: Laetitia Donaghy, Chicago, IL (US)

(72) Inventor: Laetitia Donaghy, Chicago, IL (US)

(21) Appl. No.: 18/389,159

(22) Filed: Nov. 13, 2023

Related U.S. Application Data
(60) Provisional application No. 63/441,294, filed on Jan. 26, 2023.

(51) Int. Cl. G06Q 10/02

(52) U.S. Cl. CPC G06Q 10/02

(57) ABSTRACT

A system for connecting professionals with clients, and professionals with other professionals, but the purpose of booking services and/or arranging meetings and projects. The format of the system includes, but in not limited to, desktop website and mobile application.

### FIELD OF INVENTION

The present disclosure relates to systems for booking a professional using a software application, i.e., a web application or a mobile application. The present disclosure relates to a booking app usable by people and businesses seeking to retain the services of a photographer, videographer or other professional for a wedding or other event. Booking apps of the present disclosure may be used by people and businesses to retain the services of any number of professionals for purposes of any number of events.

### BRIEF DESCRIPTION OF THE DRAWINGS

FIG. 1 is an image of an illustrative home page/landing page interface that may be included by a system and method enabled by the present disclosure.

FIG. 2 is an image of an illustrative browsing page interface (showcasing browsing by category) that may be included by a system and method enabled by the present disclosure.

FIG. 3 is an image of an illustrative browsing page interface (showcasing browsing by professional or area) that may be included by a system and method enabled by the present disclosure.

FIG. 4 is an image of an illustrative search page interface that may be included by a system and method enabled by the present disclosure.

FIG. 5 is an image of an illustrative professional profile interface that may be included by a system and method enabled by the present disclosure.

FIG. 6 is an image of an illustrative professional profile interface (showcasing professional portfolios) that may be included by a system and method enabled by the present disclosure.

FIG. 7 is an image of an illustrative professional profile interface (showcasing an About section) that may be included by a system and method enabled by the present disclosure.

FIG. 8 is an image of an illustrative professional profile interface (showcasing a portfolio by category) that may be included by a system and method enabled by the present disclosure.

FIG. 9 is an image of an illustrative professional portfolio interface (showcasing a portfolio by area) with geographic context that may be included by a system and method enabled by the present disclosure.

FIGS. 10-13 depict a flowchart showing an exemplary embodiment of architecture of a system and method enabled by the present disclosure.

### SPECIFICATION

### Background

PROBLEM FOR PROFESSIONALS—This proposed service primarily targets the needs of, without limitation, freelance photographers, videographers, and other small or solo-business owners/service providers, in the wedding or other industries. Such providers often face difficulties in booking due to their modest promotional budget and, to the few and lacking options currently afforded them. At the present moment, such professionals have the option of being found via a search engine (i.e. on Google,) of opting in to limiting and expensive directories (e.g. The Knot, Wedding Wire, Junebug Weddings . . . ) or rely on social media to draw in clients (i.e. Instagram,) none of which provides for firm, guaranteed, or regular bookings. Online search engines display many weaknesses in this context, including an expensive, time-consuming and/or relatively impossible climb to the first page of results, the risk of a false and damaging review by someone the professional may not have done business with, as well as the physical and financial risk associated with conducting business with strangers. Social media displays many weaknesses in this context, including an ever-changing algorithm, time-consuming content creation in the hopes of being seen, and increasingly limited natural reach, pushing users to pay to promote their content. Directories display many weaknesses in this context, including a prohibitively high cost, low return on investment, a high susceptibility to false leads and automated bots/web crawlers, limited functionality/customization/control, and greatly limited reach (i.e. local reach only.) At the present moment, no known platform enables professionals to be found or book on an international scale, to set their availability for more than one location, to share a Travel Calendar, to book as they travel, to “match” with others on projects, access to a back-channel of other professionals in order to hire them, the ability to set up a back-up emergency professional, and to do so with the safety of verified reviews and a company-backed warranty. Due to this lack of quality options for marketing oneself and for finding and booking clients, an extremely high number of such professionals report not booking enough to make a living off their profession.

PROBLEM FOR CLIENTS—This proposed service also targets the needs of persons looking to hire, without limitation, photographers, videographers and other service providers, for weddings and other needs. Such persons often face difficulties in finding an appropriate professional who meets all needs, and find themselves overwhelmed and underserved by the current search avenues. At the present moment, such persons have the option of doing an online search (i.e. Google,) of searching limited directories (e.g. The Knot, Wedding Wire, Junebug Weddings . . . ,) or of searching on social media (e.g. Instagram.) Online search engines display many weaknesses in this context, including the lack of verified reviews and the physical and financial risk associated with conducting business with a stranger, the overwhelming and time-consuming nature of the search based on the unmanageable number of search results, the undifferentiated nature of how the results are presented, as well as the work and time needed to manually follow up with each professional in order to narrow down results. Directories display many weaknesses in this context, including the knowledge that the resulting profiles will only be that of professionals able to afford to be listed, for a small (local) geographical area only. Social media displays many weaknesses in this context, including the lack of search filters and the knowledge that organic reach is being limited by the algorithm. At the present moment, no known platform enables the hiring party to search quickly and effectively via filters, to book on an international scale, to “match” with others on projects, and to do so with the safety of a verified reviews and a company-backed warranty.

SOLUTION FOR PROFESSIONALS—What is needed is a system and method that isn't prohibitively expensive, that allows professionals to set their availability on an international scale, to book work as they travel, to announce desired projects, to easily check “matches” and be paired with other users looking for the same thing they are, to book other professionals as needed within a trusted and reviewed network, to set up an emergency replacement, and to do so feeling safe through verified reviews and a company-backed warranty.

SOLUTION FOR CLIENTS—What is needed is a system and method that allows the hiring party a tailored and simplified search process via filters, the ability to book abroad if desired, removed financial obstacles for a broader pool of talent to choose from, organized results, the peace of mind of knowing an emergency replacement is set up, to easily check “matches” and be paired with other users looking for the same thing they are, and to do so feeling safe through verified reviews and a company-backed warranty.

### DETAILED DESCRIPTION TERMINOLOGY

The following disclosure is provided to describe various embodiments of a system for professionals and clients to connect, book and conduct business together, for weddings, events or other needs. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

As used herein the term “system administrator” is intended to refer to an information technology professional who supports a multi-user computing environment and ensures continuous, optimal performance of information technology services and support systems.

As used herein the term “electronic control component” is intended to refer to an image or text on a user interface of a computerized device, smart phone, or other similar device that, upon tapping or clicking thereon, may transmit a command signal to other system components to execute instructions.

Throughout this disclosure, various aspects are described as being saved, shared, transmitted, or otherwise communicated. Such communications may occur over a network, which may be facilitated by network interfaces operated by hardware components upon which a system or method enabled by this device may be operated. Data, information, operational code, or other content may be stored by a database, which may be accessible by a system enabled by this disclosure locally, via a network, remotely, or otherwise as will be appreciated by those of skill in the art.

As used herein, the term “contract” is intended to refer to a purported mutually binding agreement, regardless of whether or not, in actual fact, the purported contract would be deemed valid or enforceable.

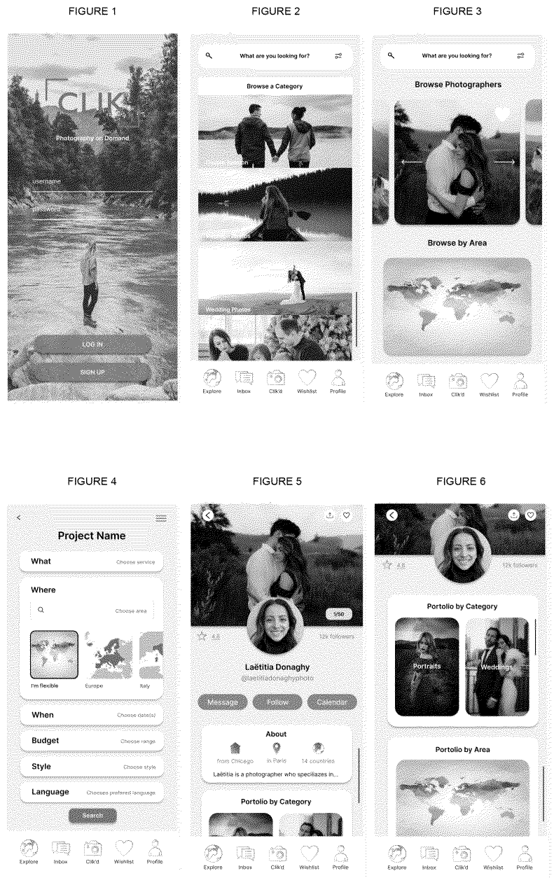

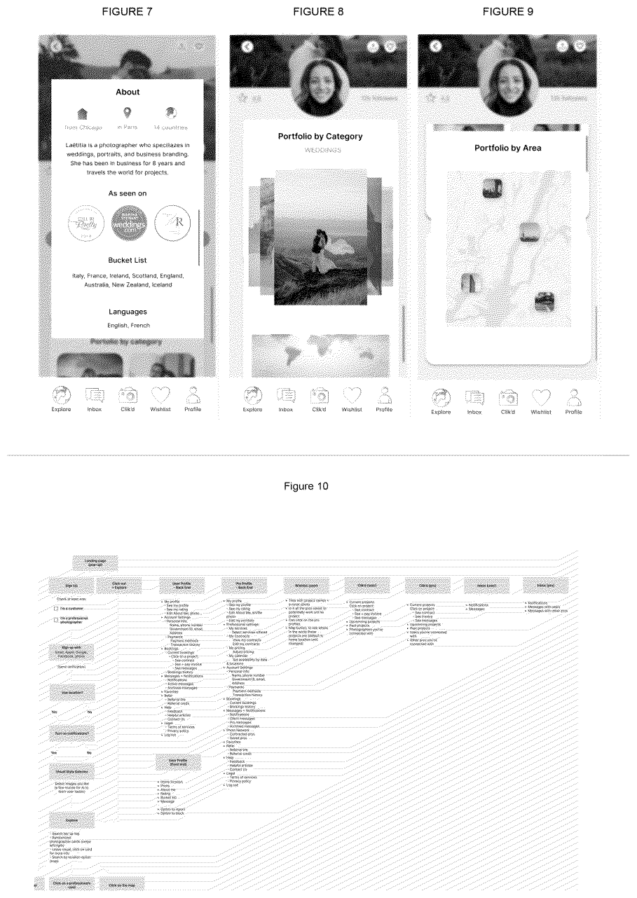

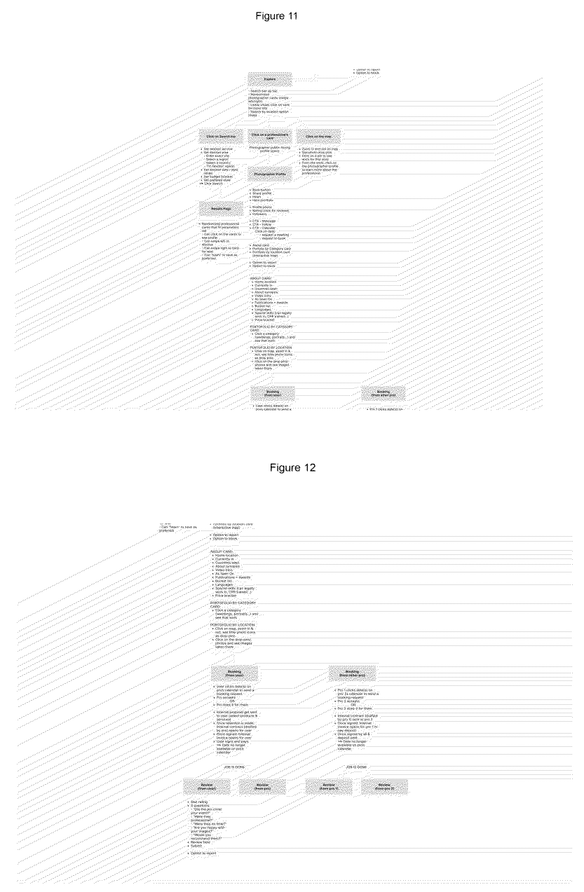

Systems of this disclosure may comprise a plurality of graphical user interfaces (GUIs). Such GUIs may, without limitation, comprise a web page, interactive interface, or other user interface accessible through the system and method enabled by this disclosure. Examples of such GIU's, in the context of a mobile app, can be found in FIGS. 1-9.

Various aspects of the present disclosure will now be described in detail, without limitation. Systems of this disclosure may be operated with the assistance of a computerized device. For example, systems enabled by this disclosure may comprise a software application, such as a web application or a mobile application, without limitation. Said application may be hosted on a server and accessible from virtually any number of client devices. Said client devices may be utilized to access the application through one or more of several different portals. Such portals may include a client portal and a professional portal (together referred to as user portal/s.) The professional portal may, alternatively, be referred to as a vendor portal or a supplier portal, without limitation.

As used herein, the term “User Profile” is intended to refer to both Client Profiles and Professional Profiles. Client Profiles are intended for service-seeking individuals. Professional Profiles are intended for service-providing individuals and may, alternatively, be referred to as vendor profiles or supplier profiles.

As used herein, the term “public-facing” profile may also be referred to as the “front-end,” “front-facing,” “community-facing” or any other similar terminology to describe the publicly accessible version of a user's profile. Similarly, “administrative profile” may also be referred to as “back-end”, “back-facing” or any other similar terminology to describe the privately accessible version of a user's profile.

### Architecture

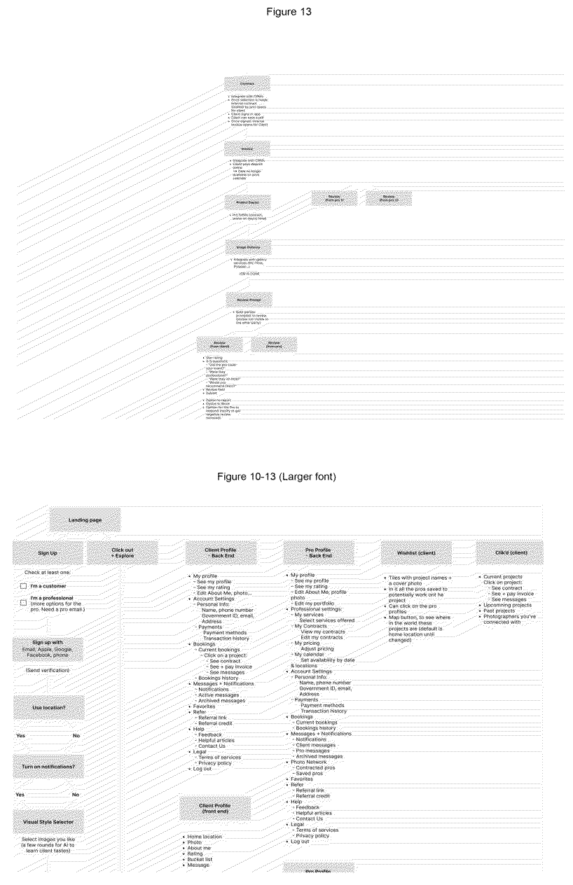

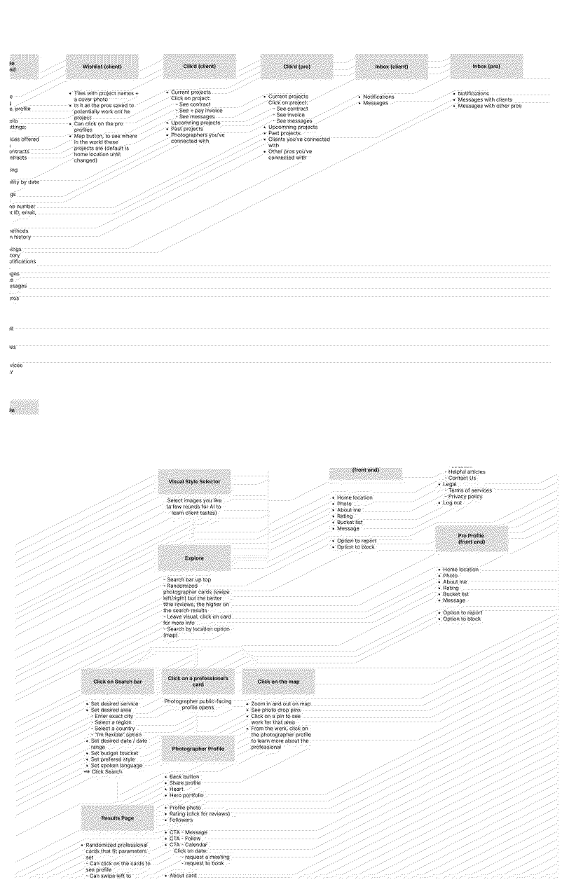

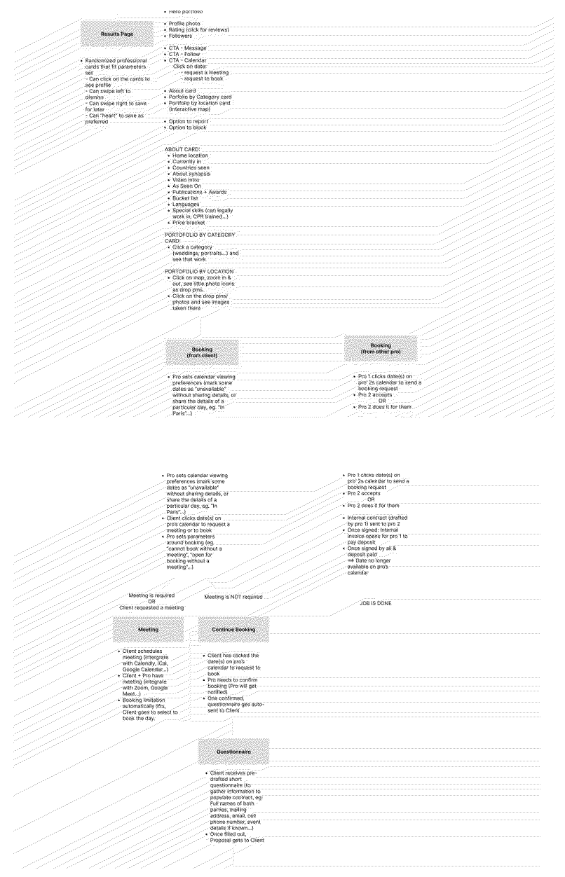

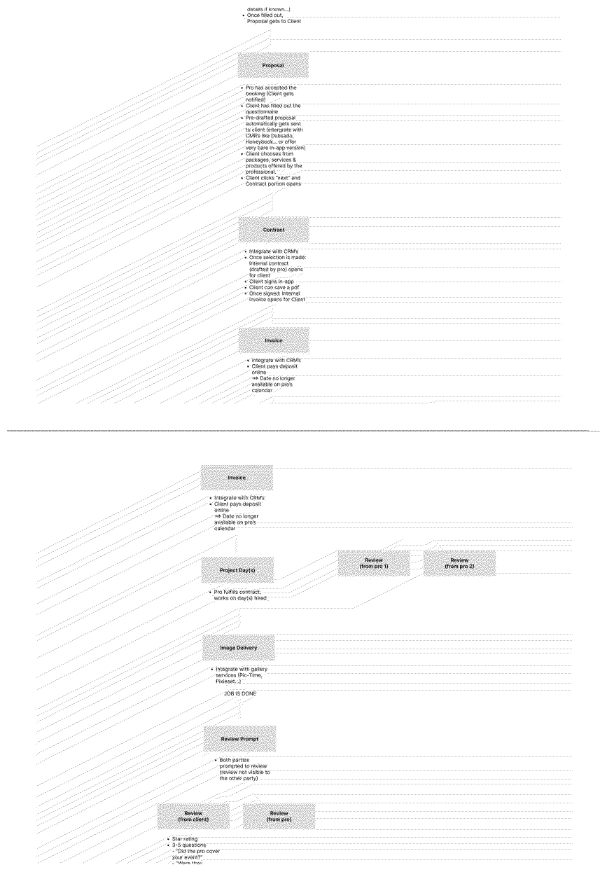

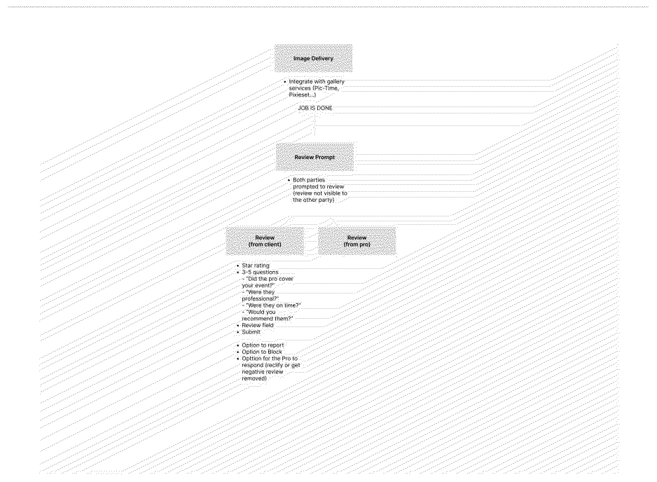

FLOWCHART—FIGS. 10-13 depict a flowchart constituting an embodiment of architecture of a system according to the present disclosure. This embodiment is adapted for use by a user to hire a photographer for a wedding. Those of skill in the art will appreciate, however, that systems of the present disclosure may be readily adapted for use by clients/customers/professionals to retain the services of any number of professionals/vendors/suppliers. Examples of the flowchart can be found in FIGS. 10-13.

LANDING PAGE—The following is a description of the mobile GUI called “Landing Page.” As used herein, the term “landing page” is intended to be substantially synonymous with the term “home page.” The landing page may comprise fields that may be populated with data, which may be storable in a database. Upon downloading the mobile application, a user will be prompted to either log in or sign up. An example of said Landing Page can be seen in FIG. 1.

SIGNING UP—By tapping or clicking on the “Sign up” electronic control component, a user may be prompted to create a login (username and password.) Such information may be communicated via a network, received by a server, processed, stored by a database, retrieved from a database, served to a user, displayed, or otherwise handled in a way that is in accordance with the scope and spirit of this disclosure, without limitation. System administrators reserve the right to alter, add to or remove any access, feature or preference in the future.

ACCOUNT SET UP—USER TYPE—After selecting “Sign up”, the user may be asked to identify their user type (i.e, a professional or a client, or another option that would be appreciated by those of skill in the art after having the benefit of this disclosure.) The purpose of this is to tailor the user's experience and the features available to them (ie. A professional may use the platform as both a service provider and a service seeker, while a client may only use the app as a service seeker.) The categories of information that may be entered into a user's account may differ depending upon whether the user is a client or professional/vendor/supplier. The categories of information that may be included in a client profile and in a professional profile are discussed further below. User profiles may be stored in a database, which may be accessible via a network, without limitation. System administrators reserve the right to alter, add to or remove any access, feature or preference in the future.

ACCOUNT SET UP—LOGIN OPTIONS—Once the user has selected their user type, the user may indicate, through manipulation of an electronic control component, the manner in which they would like to sign up and log in. Clients may do so using an email address, an Apple ID, Google, Facebook, a phone number, or any other option that may become available in the future. Professionals will have to sign up and log in using a professional email address. System administrators may decide to change this limitation in the future. Once the login information has been selected, a verification code may be sent to the user in order to proceed with account creation. A populatable field may then be presented on the screen wherein the verification code may be entered. System administrators reserve the right to alter, add to or remove any access, feature or preference in the future.

ACCOUNT SET UP—LOGIN OPTIONS—USERNAME & PASSWORD—Alternatively, the user may decide to create a username & password combination for the purposes of creating their account and logging in in the future. The application may require that said username be unique relative to pre-existing usernames stored within the application server. The application may require that said password meet certain requirements in order to be considered secure. Such requirements may include, by way of example only, that in order to be valid a password must contain a certain number of characters, at least one uppercase letter, at least one lowercase letter, and at least one number, and/or at least one special character. Those of skill in the art will readily envision many different requirements that may be applied in order for a password to be valid. System administrators may modify requirements for creating a valid password. System administrators may determine and set a threshold amount of information required to proceed to account creation. Once the login information has been created, a verification code may be sent to the user in order to proceed with account creation. A populatable field may then be presented on the screen wherein the verification code may be entered. System administrators reserve the right to alter, add to or remove any access, feature or preference in the future.

ACCOUNT SET UP—PERSONAL INFORMATION—Users may be prompted to enter their name, address, phone number and other information in order to populate their profile based on their user type. An image of the user's government-issued identification may also be uploaded to and included within an administrative version of a user's profile. For professionals, other fields may be mandatory such as, by way of example only and without limitation, website, professional email address, tax ID number, and/or proof of insurance. System administrators reserve the right to alter, add to or remove any access, feature or preference in the future.

ACCOUNT SET UP—PREFERENCES—Upon account creation, the user may be prompted to select certain preferences, including, but not limited to, whether they desire the app use their location and that their location be shared with the application server, and whether they desire notifications be turned on. An electronic control component comprising “yes” and “no” options may be displayed on the screen. A user may select either the “yes” or “no” options based on their own privacy preferences. System administrators reserve the right to alter, add to or remove any access, feature or preference in the future.

ACCOUNT SET UP—STYLE SELECTOR—In an embodiment, systems of the present disclosure may comprise a visual style selector to help tailor future search results. According to such an embodiment, a user may be presented with a plurality of images and may be presented with inquiries directed to whether, and to what extent, the user finds such images visually appealing. Systems of the present disclosure may further comprise an artificial intelligence (AI) component that may be utilized to assess the user's style preferences based on the user's feedback regarding the images (e.g., whether the user prefers a dramatic style, a traditional style, a lighter or darker editing style, a more posed or candid shooting style. etc.) The system may then apply these AI-determined style preferences when displaying professional profile results to the user. System administrators reserve the right to alter, add to or remove any access, feature or preference in the future.

ACCOUNT SET UP—ACCOUNT CREATION—Upon completion of the above-mentioned steps, the account set up process is complete, and a new client or professional account may be created automatically. The user may now sign in to their new account and access the full features of the application.

SIGNING IN—The user may access said account by finding themselves on the landing page, and inputting their login information into the populatable fields designated “username” and “password”, or through the other available methods (ie. Google, Facebook, Apple ID, phone number . . . ) and tapping or clicking an electronic control component. Said electronic control component may comprise the verbiage “sign-in,” other similar verbiage, or no verbiage at all.

USER PORTAL—ACCOUNT & PROFILE BACK-END—When a user signs into his or her account, that user may be brought to the administrative component of their account. This administrative component may comprise an administrative version of a user's profile as well as other account settings and preferences. This is where a user may populate and edit the content that will be displayed on the user's public-facing profile. To view the public-facing version of their user profile, the user may transmit an instruction to this effect by selecting an appropriately labeled electronic control component on the back-end version of the user's profile. Said control component may be labeled “view community-facing profile,” “see my profile,” “view as a member,” virtually any other language to the same effect, or no verbiage at all (i.e., an icon exclusively). System administrators reserve the right to alter, add to or remove any access, feature or preference in the future.

USER PORTAL—ACCOUNT PREFERENCES—The administrative component may further allow for a user to select one or more account preferences. Such account preference options may include, without limitation, preferred language, platform accessibility options, preferred audience (ie. who may see a user's profile such as any member subscribed to the app, or only users to whom access has been specifically granted,) payment methods, transaction history/receipts, personal information (eg. address, name, phone number), contact preferences, whether two-factor authentication should be applied, and any other preference or feature not listed above or yet implemented. System administrators reserve the right to alter, add to or remove any access, feature or preference in the future.

USER PORTAL—MESSAGES & NOTIFICATIONS—The administrative component of a user account may further comprise a communications subcomponent. The communications subcomponent may comprise one or multiple tab/s labeled “Inbox,” “Messages,” “Notifications” or virtually any other language or visual meant to communicate the same. Upon tapping or clicking thereon, the user may view all electronic messages that the user has sent and/or received through the system, archived messages, as well as electronic notifications that the user has received through the system. By way of example only, and without limitation, such a notification may be as follows: “A photographer you follow is coming to your area,” “You have a match,” “You received a message,” “You have received a payment” . . . etc. Messages and notifications may be stored by a database, which may be accessible via a network connection. System administrators reserve the right to alter, add to or remove any access, feature or preference in the future.

USER PORTAL—CONTACT—As discussed herein, systems of the present disclosure may comprise channels through which users may communicate with one another, such as via phone call and/or video conferencing. Preferences for such methods would have been set ahead of time by each user in the Preferences area of their user portal. In an embodiment, a community-facing user profile may display an electronic control component through which a user may call or request a meeting with another user. Said notification may provide for one or more response options, including, without limitation, an option to accept the request and begin communication, decline the request, schedule the request, or transmit a responsive communication indicating that the recipient of the communication request will contact the sender of the request at a future time. Video conferencing may be done via the platform or through an integrated third-party software. System administrators reserve the right to alter, add to or remove any access, feature or preference in the future.

USER PORTAL—FAVORITES—The administrative component of a user's account may further comprise a Favorites subcomponent. The Favorites subcomponent may comprise, for example, a folder/tab comprising profiles of users saved by another, or favorite images. A user may add another user to his or her Favorites folder by tapping or clicking an electronic control component which may comprise an icon on the screen. Without limitation and by way of example only, said icon may appear in the form of a heart. System administrators reserve the right to alter, add to or remove any access, feature or preference in the future.

USER PORTAL—HELP & SUPPORT—Systems of this disclosure may comprise a Help or Support component. The Help component may comprise, without limitation, a Feedback aspect, a helpful articles aspect, and a Contact Us aspect. The Feedback aspect may comprise a message template comprising fields that may be populated by a user. Upon completion of the message template, a user may transmit the corresponding message to a support entity intended to provide customer service to account holders. Such transmission may be effectuated through tapping or clicking an appropriately labeled electronic control component. The helpful articles aspect may comprise links to published resources accessible online that provide information relevant to specific technical difficulties that may be encountered by users while using the application. The helpful articles aspect may contain a search or filter tool that allows a user to search by keyword or other criteria for articles most likely to address the technical difficulties that the user is encountering. The Contact Us aspect may comprise fields that may be populated by a user to identify themselves and prepare a message identifying a technical issue or other matter with regard to which the user seeks assistance. The Contact Us aspect may comprise a message template comprising fields that may be populated by a user. Upon completion of the message template, a user may transmit the corresponding message to a support entity intended to provide technical support and/or customer service to users of the application. Such transmission may be effectuated through tapping or clicking an appropriately labeled electronic control component. System administrators reserve the right to alter, add to or remove any access, feature or preference in the future.

USER PORTAL—LEGAL COMPONENT—Systems of the present disclosure may comprise a Legal component. The legal component may comprise a Privacy Policy as well as a Terms of Service aspect. The Privacy Policy aspect may comprise a set of disclosures indicating whether and to what extent information submitted by a user through the application may be accessible to others. The Terms of Service aspect may comprise a set of terms and conditions to which a user must agree before creating a user account, or that a user may be deemed to have impliedly agreed to by proceeding with creating their user account. In an embodiment, a user may be required to agree to the Terms of Service as a prerequisite to creation of their user account. Such agreement may be effectuated through manipulation of an electronic control component labeled “I agree to the terms of service” or virtually any other language to a similar effect. In an embodiment, the legal component may be accessible through a suitably labeled link appearing on a landing page, the user portal and/or through any additional/different web pages within the application. System administrators reserve the right to alter, add to or remove any access, feature or preference in the future.

USER PORTAL—LOGGING OUT—The administrative component of a user account may further comprise a log out subcomponent. The log out subcomponent may comprise an electronic control component that may be manipulated by a user to exit the system and terminate an operative connection between the user's device and the system. Upon logging out of the system, none of the functionality of the system as discussed herein may be available to the user unless and until the user logs back into their account. System administrators reserve the right to alter, add to or remove any access, feature or preference in the future.

PROFESSIONAL PORTAL—Professionals who have created an account may access a professional portal. Through this portal, a professional may create and edit any information, including, but not limited to, their public-facing profile information, their personal information (e.g. name, address, phone number . . . ,) their settings and account preferences, their password or login, their preferred payment methods, transaction history/receipts. They may set up and populate their portfolio, the services offered, pricing, and calendar/availability. They may have access to a multitude of features including, but not limited to, their notifications, the log out function, the accounts they have blocked/restricted, the Privacy Policy, Terms of Service and other legal disclaimers. They may have access to the Support Center. They may have access to all profiles, communications, contracts and invoices with any user (client or professional) they did, are, or will be doing business with. In addition, professionals may have access to a dedicated area for connecting with other professionals (ie. A “professional back-channel) through which they may communicate with, organize projects and events with, and/or book other professionals. By way of example only, and in the case of photographers, they may hire other professionals as associate shooters, lead shooters, second shooters, emergency back-up shooters, shooting assistants, non-shooting assistants, editors and more. Professionals may make announcements that would be displayed in a “public feed” (reserved for members only) to communicate a desire or plan (eg. “Planning a styled shoot and looking for a couple to model”, “Will be in California, would love to connect with local professionals while there” . . . ) They may have access to any number of tools and features not listed above or yet developed. A professional may then publish (ie. make public) their profile, including edits that have been made, by tapping or clicking a designated electronic control component. The features herein listed are examples only and may not encapsulate the entirety of the features that may be offered to users. System administrators reserve the right to alter, add to or remove any access or feature in the future.

CLIENT PORTAL—Clients who have created an account may access a client portal. Through this portal, a client may create and edit any information, including, but not limited to, their public-facing profile information, their personal information (e.g. name, address, phone number . . . ,) their settings and account preferences, their password or login, their preferred payment methods and receipts. They may have access to a multitude of features including, but not limited to, their notifications, the log out function, the accounts they have blocked/restricted, the Privacy Policy, Terms of Service and other legal disclaimers. They may have access to the Support Center. They may have access to all profiles, communications, contracts and invoices with any user/professional they did, are, or will be doing business with. Clients may make announcements that would be displayed in a “public feed” (reserved for members only) to communicate a desire or plan (eg. “My spouse and I are traveling to Colorado, hoping to line up with a professional” . . . ) They may have access to any number of tools and features not listed above or yet developed. System administrators reserve the right to alter, add to or remove any access or feature in the future.

USER PROFILES—Embodiments of systems of this disclosure may comprise client profiles and professional profiles (together referred to as “User Profiles.”) Professional profiles may, alternatively, be referred to as vendor profiles or supplier profiles. In some embodiments, profiles may be stored by a database, which may be operatively connected by and accessible via a network. User profiles may comprise elements accessible and manipulable through an administrative component of the system. This administrative component, which may also be referred to as the back-end component, may be viewed only by the user and system administrators. User profiles may consist of a back-end, private view with administrative controls available to the user, as well as a front-end, public view. Public-facing profiles may or may not be accessible to non-account holders. System administrators reserve the right to alter, add to or remove any access or feature in the future.

USER PROFILES—SHARING & REFERRING—Profiles and images may further comprise a Sharing or Referrals subcomponent. Said subcomponent may allow, for example, for a user to share/refer another user to someone by sharing that user's profile, internally or via other platforms (eg. Share to Facebook, Share via Email . . . etc.) The referral may be effectuated through the application by manipulating an electronic control component, which may be labeled “Refer this Professional to Another User”, “Refer this User to Someone,” “Share this Profile” or virtually any other verbiage to a similar effect, or may consist exclusively of an icon without any verbiage. This electronic control component may appear on each user's profile. Images may be shared in a similar manner. The referrals subcomponent may further comprise a list of referrals that have been made by a user to another. Systems administrators may or may not set a referral program with credits to be calculated and earned by a user pursuant to a formula stored in a database or on a server. System administrators reserve the right to alter, add to or remove any access, feature or preference in the future.

PROFESSIONAL PUBLIC PROFILE—CONTENT—In an embodiment, a professional's public-facing profile may include by way of example only and without limitation, a photo of the professional, a “hero portfolio” (ie. A certain number of the professional's favorite images), their name, handle, number of followers, composite star-rating, reviews, and hashtags that may reflect their interests or projects (e.g. “weddingphotographer”, “usaphotographer” . . . etc.) Professionals may be able to announce on their profile or on the public Community Wall where they will be and what they are looking for (eg. “Going to Portugal, looking for a couple to photograph.” There may be an area called “See my Travel Calendar”, “See my Travel Itinerary”, “See My Upcoming Travel” or any other terminology to communicate the same, where users may see a list view of the professional's upcoming travel. There may be an area called “See my Past Travel” or any other terminology to communicate the same, meant to share with users past travel experiences, with images from said travels available for viewing. A professional's public-facing profile may include, among others, an About card, a Portfolio by Category card, a Portfolio by Location card, and a Calendar. The About card may include by way of example only, where the professional is from, their current location, the number of countries they have been to/worked in, a synopsis/blurb about them, a video introduction, their level of experience, their calendar with availability, an “Available for” section (ie. Where the professional defines the types of projects they wish to be hired for,) a “Bucket List/Wishlist” section, a “As Seen On/Publications” area, an Awards area, a Languages Spoken area, a Specials Skills area, a Legally Allowed to Work In area . . . etc. The Portfolio by Category card may allow the user to view work produced by the professional in those categories. The Portfolio by Area card may allow the user to click on an interactive map in order to view work produced by the professional in various areas. Said map may have “drop pins” to show geotagged images taken at a specific location. All features and names referenced above are by way of example only and may be changed in the future. Systems administrators reserve the right to change, add to or remove from the above-listed features and items. Examples of a professional profile can be found in FIGS. 5-9.

PROFESSIONAL PUBLIC PROFILE—ACTIONS—In an embodiment, a professional's public-facing profile may include by way of example only and without limitation, a number of actions available to viewing users, including, but not limited to, leafing through the professional's portfolio, saving some of their images in a “Favorites” folder, sharing images with other users, sharing the profile with other users, saving the profile to be reviewed later, saving the profile in a “Favorites” folder, a “Send a Message” button or option, a “Contact” option to initiate a phone or video call (based on preferences set by the professional), a “Follow” option (in order to receive notifications about their activities,) an interactive calendar, and requesting a booking/proposing a scheduled meeting or project, a “Hide Profile” function (so the profile won't show up in results of searches in the future,) a “Block”/“Unblock” function, and a “Report” function. While viewing past travels, users may be able to click on the names of places the professional has traveled to in order to see work he/she has produced there. While looking through the professional's portfolios (whether by category or area/location,) the user may be able to click on each to view more. Systems administrators reserve the right to change, add to or remove from the above-listed features and items.

PROFESSIONAL CALENDAR—The Calendar feature on a professional's profile is an interactive interface that allows the professional to share their availability with other users on an international scale. The professional may mark a length of time as “open/available” or “closed/unavailable” without revealing any more information, or give more information if they so desire. By way of example only, they may mark themselves as “open for” and describe the type of work they are willing to perform during a particular time period or on an ongoing basis (e.g. “Open for second shooting”, “open to local projects only”, “open for travel projects” . . . ) They may share their travel plans (ie. “Travel Calendar”) in order to book work during their travel, by marking a length of time as such (eg. “Traveling to Italy, looking for work while there”.) They may share their desire/willingness to travel to and availability for work in a particular location during particular dates (eg. Available to travel for work in France, Italy, Spain and Portugal during the following dates” . . . etc.) The purpose of the Calendar is to communicate one's availability both locally and beyond one's local geographical area. The calendar may have an area called “See my Travel Calendar”, “See my Travel Itinerary”, “See My Upcoming Travel” or any other terminology to communicate the same, where users may see a list view of the professional's upcoming travel. There may be an area called “See my Past Travel” or any other terminology to communicate the same, meant to share with users past travel experiences. The calendar may have an area called “See my Wishlist,” “See my Bucketlist” or any other terminology to communicate the same, where users may see where a professional wishes to book work. If two users will be in the same place at the same time, the days in their calendar will turn green while viewing (or otherwise demonstrate a match in time and place.) If two users have matching wishlist items and dates, their calendar will visually demonstrate a match and they may receive a notification of such. Users may be able to click on the names of places traveled to in order to see work the professional has produced there during that visit. Users may use the calendar in order to propose a meeting or project with the professional. Preferences prior-set by the professional will either allow the request to automatically come through and be scheduled if available, or will set requirements prior to scheduling (e.g. “Must meet before booking,” “Must approve all requests,” . . . ) With each item added to their calendar, the professional may set preferences around whether to notify users who follow them or not. All terms, including “Travel Calendar”, are by way of example only and may be altered by the Systems Administrators. System administrators reserve the right to alter, add to or remove any access, feature or preference in the future.

CLIENT PUBLIC PROFILE—In an embodiment, a client's public-facing profile may include by way of example only and without limitation, their name, handle, a photo of the client, languages spoken, number of followers, a composite star-rating/reviews, and hashtags that may reflect their interests or projects. Said profile may have an About section, where the client lives, where they currently are and where they have traveled. It may further have a “Wishlist” or “Bucket List” with projects or destinations the client wishes to organize a project in or travel to. It may have a Calendar. It may further have a “Looking for” section listing the types of services the client wishes to find (eg. “Looking for a local Chicago photographer for a family session”. . . Looking for an American photographer to shoot our vacation in France” . . . “Looking for a photographer local to Spain for our wedding” . . . ) Client may be able to announce on their profile or on the public Community Wall where they will be and what they are looking for (e.g. “Will be traveling Italy 6/1-6/15, looking for a photographer, open to modeling, open to going to nearby countries” . . . ) There may be an area called “See my Travel Calendar”, “See my Travel Itinerary”, “See My Upcoming Travel” or any other terminology to communicate the same, where users may see a list view of the client's upcoming travel. There may be an area called “See my Past Travel” or any other terminology to communicate the same, meant to share with users past travel experiences. Systems administrators reserve the right to change, add to or remove from the above-listed features and items.

CLIENT PUBLIC PROFILE—ACTIONS—In an embodiment, a client's public-facing profile may have a number of actions available to viewing users, including, but not limited to, a “Message” function, a “Contact” option to initiate a phone or video call (based on preferences set by the client,) a “Save Profile” function, an “Add to Favorites” function, a “Save for later” function, a “Share User Profile” function, an interactive “Calendar” function, a “Hide Profile” function (so the profile won't show up in results of searches in the future,) a “Block”/“Unblock” function, and a “Report” function. Systems administrators reserve the right to change, add to or remove from the above-listed features and items.

CLIENT CALENDAR—The Calendar feature on a client's profile is an interactive interface that allows the client to share their travel plans with other users on an international scale such that they may “match” with another user. If two users will be in the same place at the same time, the days in their calendar will turn green while viewing (or otherwise demonstrate a match in time and place.) If two users have matching wishlist items and dates, their calendar will visually demonstrate a match. A user may propose a meeting or project to a client. The calendar may have an area called “See my Travel Calendar”, “See my Travel Itinerary”, “See My Upcoming Travel” or any other terminology to communicate the same, where users may see a list view of the client's upcoming travel. With each item added to their calendar, the client may set preferences around whether to notify users who follow them or not. All terms, including “Travel Calendar”, are by way of example only and may be altered by the Systems Administrators. Systems administrators reserve the right to change, add to or remove from the above-listed features and items.

MATCHING—An extension of the calendar, search and hashtag features is the “Matching” feature. When users do a Search, a Project is automatically created in their portal. Said Project may be a specific event taking place in a specific place on a specific date, or it may be an open-ended item on their Wishlist. When two users have matching needs/desires and matching dates, the systems will notify them of a “Match,” that they have “Clik'd”, or any other terminology to communicate the same (Eg. “You Have a Match! Laetitia Donaghy Photography will be in France during your selected dates” or “You Have Clik′d! Jess and Tyler are looking for photos in Italy during your selected dates” . . . etc.) Further, a user may select an appropriately labeled electronic control component labeled “See My Clik′d Matches,” “See My Matches” (or any other terminology or visual to communicate the same) to check for any new matches to their projects. Systems administrators reserve the right to change, add to or remove from the above-listed features and items.

BROWSING—A browsing page (or “Explore” page) may allow users to browse by category, by professional, by geographical area or by hashtag. The browsing page may comprise a search field at the top. Systems administrators reserve the right to change, add to or remove from the above-listed features and items. An example of said Browsing Page can be seen in FIGS. 2-3.

BROWSING BY CATEGORY—When browsing by category, a user may choose from a list of service categories (e.g, in the field of photography, categories may include, without limitation, “Weddings”, “Couple sessions”, “Family sessions” . . . etc.) Within a category, images may be displayed at random, by rating, or in any other manner chosen by the user and/or as set by system administrators. The user may refine the results by setting filters or select the manner in which they wish to view the results (eg. “View by rating”, “View by home location”, “View by current proximity”, “View by experience level”, “Exclude results with” . . . etc.) The user may quickly swipe between images to “dismiss” or “save for review”, click a “heart” icon to “save to favorites”, share images, or click on the images to learn more about the professional who took them. The user may also refine the results by setting filters to narrow down results. System administrators reserve the right to alter, add to or remove any access or feature in the future.

BROWSING BY PROFESSIONAL—When browsing by professional, the user may see professional “cards” displaying an image chosen by each professional. Professionals' profiles may be displayed at random, by rating, or in any other manner chosen by the user and/or as set by system administrators. The user may refine the results by setting filters or select the manner in which they wish to view the results (eg. “View by rating”, “View by home location”, “View by current proximity”, “View by experience level”, “Exclude results with” . . . etc.) The user may quickly swipe between cards to “dismiss” or “save for review”, click a “heart” icon to “save to favorites”, or click on the card to learn more about the professional. System administrators reserve the right to alter, add to or remove any access or feature in the future.

BROWSING BY AREA—When browsing by geographical area, the user may click on an interactive map, digitally navigate to the desired location, or manually enter a location. The user may further zoom in or out on the map. Drop pins will show geotagged images taken at various locations. The user may click on said drop pins in order to see images taken there. While viewing the images, the user may swipe to dismiss or save for later review, save an image as a favorite, share an image, or click on an image to learn more about the professional who took it. The user may also refine the results by setting filters. System administrators reserve the right to alter, add to or remove any access or feature in the future.

BROWSING BY HASHTAG—A user may simply browse by entering one or multiple hashtags in the Search field/bar (eg. #franceweddings #usaphotographers.) Results may display randomly, by rating, or in any other manner chosen by the user and/or as set by system administrators. The user may refine the results by setting filters or select the manner in which they wish to view the results (eg. “View by rating”, “View by home location”, “View by current proximity”, “View by experience level”, “Exclude results with” . . . etc.) While viewing the image results, the user may swipe to dismiss or save for later review, save an image as a favorite, share an image, or click on an image to learn more about the professional who took it. System administrators reserve the right to alter, add to or remove any access or feature in the future.

SEARCHING—In an embodiment, a GUI of systems of the present disclosure may comprise a web page or tool (ie. Search Bar) through which a user may perform a search for services. Said search bar may comprise the verbiage “What are you looking for?”, any other verbiage or no verbiage at all. The options presented in the search field may be tailored to the user type (eg, a professional user may have the option to search for another professional to hire as a subcontractor, along with preferences relating to that, while a client may not.) Upon clicking in the search bar, a user may enter text into this search field, and/or be presented with pre-selected search parameters. Said search parameters may include “What” (ie. what service is needed), “Where” (ie. what location(s) is/are desired), “When” (ie. what date/s are needed/desired), “Budget” (ie. how much is the user looking to spend”), “Style” (ie. what style is preferred), “language” (ie. what spoken language is needed/preferred), and virtually any other parameter to be set by system administrators. System administrators may decide which parameters are mandatory and which are not in order for a search to be performed. The user may have the option to “add notes” to their search (which would be viewable by other users if they chose to share their search to the Community Wall.) Users may “Share search to community wall” if they so desire. When entering a location, the user may be presented with preselected options (ie. “Europe”, “USA”, “I'm flexible”) or the option to manually enter a location. The user may be presented with preference options for each parameter (ie. selecting a particular parameter as a “must”, a “preference”, or “no preference.” E.g. “Vendor language: English. Preference: “Must/Preferred/No preference.”) Users may select to “exclude” certain parameters/keywords in their search. Once search parameters have been entered, the user may tap or click the electronic component to send the search through. System administrators reserve the right to alter, add to or remove any access or feature in the future. An example of said Search Page can be seen in FIG. 4.

POSTS TO COMMUNITY WALL—In lieu of or in addition to a search, a user may opt to post on a “Wall” the same way one might on social media (eg. “Looking for a photographer for my Paris trip” or “Going to Spain for the first time, looking for recommendations”) and select the audience (ie. “All users”, “professionals only”, or “clients only”.) Users will have the option to privately contact the author or the post if they desire. System administrators reserve the right to alter, add to or remove any access or feature in the future.

SEARCH RESULTS—Upon performing the search, the user may be presented with one or more search results related to the terms entered into the search field, presented at random, by rating, or in any other manner determined by system administrators. The user may then swipe through results, “Dismiss/Hide” a result that they don't like, “Hide forever” a profile they do not wish to see in future search results. Users may also narrow results further by selecting more filters, or select the manner in which they wish to view the results (eg. “View by rating”, “View by home location”, “View by current proximity”, “View by experience level”, “Exclude results with” . . . etc.) Users may review results/profiles they have “saved for review” or “dismissed” in each Project tab in their user portal. System administrators reserve the right to alter, add to or remove any access or feature in the future.

PROJECTS—Upon performing a search, a new “Project” will be created and added to a user's portal. A user may name a project (eg. “Wedding 2025”) and select whether a particular project has a date or is a “Wishlist” item. Based on this, the project will be added to the appropriate “folder.” Users may access and edit/refine their projects at any time by going to the “Projects” tab in their user portal. From the Projects tab a user may access past, current, future (ie. “Bookings”) and unassigned “Wishlist” projects. Once a project is selected, a user may see all documentations associated with that project (eg. messages, contracts, invoices, receipts . . . etc.) A user may also perform certain tasks associated with that project (eg. Sign a contract, save/download a contract, pay an invoice, save a receipt of payment, send a message to all users associated with the project . . . etc.) Content accessible via the Projects tab may be stored in and/or retrieved from a connected database. System administrators reserve the right to alter, add to or remove any access or feature in the future.

WISHLIST/BUCKET LIST—Users may access their “Wishlist” (or Bucket List) in their Projects tab. A user's Wishlist comprises projects they hope to fulfill (eg. “France photoshoot”.) There they may create, view, edit or delete all such projects and see any profile or image they saved in association for such project. System administrators reserve the right to alter, add to or remove any access or feature in the future.

BOOKING REQUESTS—CLIENT TO PROFESSIONAL—In an embodiment, clients may initiate a booking request for a photographer or other professional through that professional's profile or through their calendar. A client may request a booking by tapping or clicking on an electronic control component located on a professional's profile comprising the verbiage “book now,” “request a booking” or any other verbiage to a similar effect, or no verbiage at all (e.g., an icon without any words). The professional may set parameters for what information in the request is or is not mandatory (eg. date, location . . . ) The execution of the booking request may be subject to parameters pre-set by the professional (eg. “Must meet before booking” or “Accept all bookings automatically.”) The contract, terms, and fees may be left to the discretion of the professionals. The parties may communicate about the project and send/receive time-sensitive notifications about the project through the interface. System administrators reserve the right to alter, add to or remove any access or feature in the future.

BOOKING REQUESTS—PROFESSIONAL TO PROFESSIONAL—In an embodiment, professionals may be able to hire other professionals through that professional's profile or through their calendar. By way of example only, and in the case of photographers, they may hire other professionals as associate shooters, lead shooters, second shooters, emergency back-up shooters, shooting assistants, non-shooting assistants, editors and more. A professional may find another by doing the same search a client might, or by putting out an announcement on the Community Wall that another might answer. The booking professional may request a booking by tapping or clicking on an electronic control component located on a professional's profile comprising the verbiage “book now,” “request a booking” or any other verbiage to a similar effect, or no verbiage at all (e.g., an icon without any words). The second professional may set parameters for what information in the request is or is not mandatory (eg. date, location . . . ) The execution of the booking request may be subject to parameters pre-set by the second professional (eg. “Must meet before booking” or “Accept all bookings automatically.”) The contract, terms, and fees may be left to the discretion of the professionals. The parties may communicate about the project and send/receive time-sensitive notifications about the project through the interface. System administrators reserve the right to alter, add to or remove any access or feature in the future.

BOOKING—PROPOSAL ITEMS—In an embodiment, once a booking request has been accepted (automatically or manually,) the user who initiated the request may automatically be sent, through a portal, an electronic form to complete. Such form may contain a plurality of fields such as, without limitation, name, address, phone number, email address, and project details. According to some embodiments, upon completion of fields of the form, such information may be populated into an electronic template of a draft contract comprising terms of a booking. Users may also be provided with an option to message each other or to schedule a meeting/call, as such communication may facilitate finalization of details related to a booking. According to such an embodiment, once the form is completed, the hiring user may be presented with a Proposal. Said Proposal may be presented in three steps: Selection of products and services, viewing and signing of contract, viewing and payment of invoice. Said contract may be signed electronically through the system and saved within the system and/or a copy downloaded. Said invoice may be paid according to a predetermined payment schedule through the system, marked as such in the system, and a receipt may be saved/downloaded. Once the contract is signed by both parties and the deposit paid, the booking may be automatically confirmed and both parties notified. System administrators reserve the right to alter, add to or remove any access or feature in the future.

BOOKING—CANCELLATIONS—If at any point either user wishes to cancel the booking process, they may do so so long as the contract portion has not been signed by them. A professional may also set their proposal to automatically expire and a booking request to be archived should the hiring party not respond/tend to the proposal in a predetermined time frame, so long as the contract portion has not been signed by them. In such a case, both parties would be notified. System administrators reserve the right to alter, add to or remove any access or feature in the future.

BOOKING—THIRD PARTY INTEGRATION—Booking and other aspects of systems of the present disclosure may operate in tandem with external customer relationship management and/or other software as may be possessed by a professional utilizing the system. System administrators reserve the right to alter, add to or remove any access or feature in the future.

EMERGENCY BACK-UP HIRES—An emergency back-up professional is someone who marks themselves as available on “short-notice” (a criteria to be determined by each user,) who agrees to hold a date (for a fee and with an in-platform contract) and agrees to being contacted same-day should the need arise. The hiring professional will be prompted to notify the back-up photographer on the project date as to whether or not their services are needed. When the back-up professional is needed and receives the notification, the back-up professional may be prompted to acknowledge that their services as back-up professional are needed and to confirm that they remain available and intend to cover the event. If and when the back-up professional acknowledges the request for their services and confirms their availability and intention to cover the event, such as by tapping or clicking on a suitably labeled electronic control component, the professional for whom the back-up professional is serving as a back-up, as well as the client, may receive a notification so informing them. System administrators reserve the right to alter, add to or remove any access or feature in the future.

PRODUCT DELIVERY—In an embodiment, in the case of digital product delivery (eg. photographs or videos), said products may or may not be delivered through the platform, with or without integrating a third-party software. Both users will be prompted to verify product delivery. System administrators reserve the right to alter, add to or remove any access or feature in the future.

CONCLUSION OF PROJECT—In an embodiment, once the services are rendered and all products delivered (where applicable,) and before closing the project, both users will be prompted to answer a series of questions meant to determine whether all aspects of the project have been fulfilled. Such questions may include, by way of example only and without limitation “Did your project happen?” “Did the user show up?” “Were the services rendered?” “Were the products delivered?” “Is your project completed?” Answering in the affirmative will automatically archive the project for all parties and trigger the review process. If either party has an issue, they also have the option of contacting the other party and/or contacting Support. System administrators reserve the right to alter, add to or remove any access or feature in the future.

VERIFIED REVIEWS—In an embodiment, systems of the present disclosure may further comprise a review aspect. Once a project date has passed and the Conclusion of Project questions have been answered, both parties may be prompted to leave a review on their experience. Only members of the platform may review other users, only for projects booked on the platform, rendering such reviews “verified.” A user may not have access to reviews left about them until they themselves have reviewed the other user, in order to ensure the honesty of all reviews. Once both sides have left a review, both will have access to the review left about them, and the ability to dispute it if necessary. In the case of services that involve the delivery of tangible and/or intangible/digital products that take time to produce (eg. photography, videography), a two-part review process or otherwise the ability to alter their original review may be offered to the hiring party, such that they may review both the service and the product/s. The review aspect may comprise a questionnaire and comment field. By way of example only, such questions may include “Did your professional come to your event? Were they professional? Would you recommend them?” or any other question set by the System Administrators to rate conduct and quality to service and product. A user completing a review may indicate their degree of satisfaction with their experience through a system of stars (or any other rating parameter/visual icon) wherein a higher number of stars indicates a higher degree of satisfaction with the experience (eg, the user may indicate one star, two stars, three stars, four stars, or five stars, indicating their degree of satisfaction, in ascending order, with the experience.) Upon completion of a review, a user may submit said review by tapping or clicking an electronic control component appearing on a web page within the application labeled “submit review” or any other similar verbiage. The review aspect may comprise a composite score based on individual reviews provided by a plurality of users. Said composite score may be calculated automatically and updated in substantially real-time upon receipt of a new review. Said calculation may be pursuant to pre-programmed formulae residing within the network environment of the application. The composite score formulae may be programmed by one or more system administrators. User reviews may potentially affect a user's visibility on the platform. System administrators reserve the right to alter, add to or remove any access or feature in the future.

REVIEWS—OTHER OPTIONS—The review aspect may further comprise one or more electronic control components comprising one or more of the following labels (or variations thereof): “Contact Support,” “Report,” “Block,” “Report & Block,” and “Boost/Praise.” The “Contact Support” option may allow a reviewer to communicate with customer service personnel regarding a professional's performance or conduct with regard to a project with which the reviewer was involved. The “Report” option may allow a reviewer to report a complaint to customer service personnel regarding a professional's performance or conduct with regard to a project with which the reviewer was involved. The “Block” option may block the user's profile so they may not have any future contact with the other user. The “Report & Block” option may allow a reviewer to report a complaint to customer service personnel regarding a professional's performance or conduct with regard to a project with which the reviewer was involved and further to “block” said professional as described further herein. The “Boost/Praise” option may allow a reviewer to publicly praise the user. Doing so may further “enhance” that user's profile and potentially increase their visibility. System administrators reserve the right to alter, add to or remove any access or feature in the future.

WARRANTY/GUARANTEE—In an embodiment, administrative components of systems of the present disclosure may comprise a warranty aspect. This warranty aspect may comprise a GUI through which a client may request a partial or full refund of fees paid by the client through the system for a particular project(s), or other desired outcome. The GUI may identify one or more grounds for requesting the refund/action. Such grounds may include, without limitation, that a user that was booked for a project never appeared for said project, or that deliverables related to a project were never delivered to the hiring user (eg. photographs taken in connection with a project were never delivered to the user.) The GUI may comprise a radio button, check box, or other suitable field through which a user may identify the applicable grounds supporting their refund request. The GUI of the warranty aspect may comprise a field into which a user may enter text providing further description regarding matters relevant to their refund request. The GUI of the warranty may comprise an “attachment” field meant for users to attach documentation supporting their claim. The GUI of the warranty aspect may comprise one or more additional questions designed to solicit information relevant to an assessment of whether or not a refund or other action is appropriate under the circumstances. Upon completion of some or all fields within the GUI of the warranty aspect, the user may be presented with an electronic control component providing for submission of the request. Said electronic control component may be labeled with verbiage of a nature that may inform the client with regard to the function(s) served by the electronic control component. By way of example only, said verbiage may comprise “Submit”. System administrators reserve the right to alter, add to or remove any access or feature in the future.

THIRD-PARTY SOFTWARE INTEGRATION—Those of skill in the art will readily appreciate that systems of the present disclosure may yield synergistic effect when combined with other complimentary services and products. Without limitation, in an embodiment directed to booking photographers for weddings and other events, sample photographs comprising a professional's portfolio may be imported into the system directly from an independently existing database of photographs. More generally, embodiments of systems of the present disclosure directed to booking photographers may function in tandem with external applications and software for storing image, video-conferencing, booking, contracts, invoices and/or client management. System administrators reserve the right to alter, add to or remove any access or feature in the future.

An illustrative computerized device will now be discussed in greater detail, without limitation. The computerized device may include a processor, memory, network controller, and optionally an input/output (I/O) controller. Skilled artisans will appreciate additional embodiments of a computerized device that may omit one or more of the aforementioned components or include additional components without limitation. The processor may receive and analyze data. The memory may store data, which may be used by the processor to perform the analysis. The memory may also receive data indicative of results from the analysis of data by the processor.

The memory may include volatile memory modules, such as random-access memory (RAM), or non-volatile memory modules, such as flash-based memory. Skilled artisans will appreciate the memory to additionally include storage devices, such as, for example, mechanical hard drives, solid state data, and removable storage devices.

The computerized device may also include a network controller. The network controller may receive data from other components of the computerized device to be communicated with other computerized devices via a network. The communication of data may be performed wirelessly. More specifically, without limitation, the network controller may communicate and relay information from one or more components of the computerized device, or other devices and/or components connected to the computerized device, to additional connected devices. Connected devices are intended to include data servers, additional computerized devices, mobile computing devices, smart phones, tablet computers, and other electronic devices that may communicate digitally with another device. In one example, the computerized device may be used as a server to analyze and communicate data between connected devices.

The computerized device may also include an I/O interface. The I/O interface may be used to transmit data between the computerized device and extended devices. Examples of extended devices may include, but should not be limited to, a display, external storage device, human interface device, printer, sound controller, or other components that would be apparent to a person of skill in the art. Additionally, one or more of the components of the computerized device may be communicatively connected to the other components via the I/O interface.

The components of the computerized device may interact with one another via a bus. Those of skill in the art will appreciate various forms of a bus that may be used to transmit data between one or more components of an electronic device, which are intended to be included within the scope of this disclosure.

The computerized device may communicate with one or more connected devices via a network. The computerized device may communicate over the network by using its network controller. More specifically, the network controller of the computerized device may communicate with the network controllers of the connected devices. The network may be, for example, the internet. As another example, the network may be a WLAN. However, skilled artisans will appreciate additional networks to be included within the scope of this disclosure, such as intranets, local area networks, wide area networks, peer-to-peer networks, and various other network formats. Additionally, the computerized device and/or connected devices may communicate over the network via a wired, wireless, or other connection, without limitation.

While various aspects have been described in the above disclosure, the description of this disclosure is intended to illustrate and not limit the scope of the invention. The invention is defined by the scope of claims included by a corresponding non-provisional patent application with and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

The method for designing the platform may include, but is not limited to, the use of AI technology and coding.

1. Claim
